(19) United States
(12) Patent Application Publication
(10) Pub. No.: US 2026/0321079 A1
(43) Pub. Date: Oct. 15, 2026

(54) METHOD AND SYSTEM FOR AUTOMATED STORAGE CONTAINER ACCESS

(71) Applicant: Truist Bank, Charlotte, NC (US)

(72) Inventors: Ali Rezajoo, Charlotte, NC (US); Leila Esfandiari, Indian Trail, NC (US)

(73) Assignee: Truist Bank, Charlotte, NC (US)

(21) Appl. No.: 19/174,037

(22) Filed: Apr. 9, 2025

(51) Int. Cl. G07C 9/00; B25J 9/16; G06F 21/32; G07C 9/37

(52) U.S. Cl. CPC G07C 9/00912; B25J 9/1664; G06F 21/32; G07C 9/00563; G07C 9/37

(57) ABSTRACT

A method for providing automated access to a storage container includes: receiving a request for access to a specific storage container that is located in a first secure enclosure; verifying the authenticity of the request, using at least one biometric factor; moving a robot into the first secure enclosure; and coupling the robot to the specific storage container.

### FIELD OF THE INVENTION

This invention relates generally to the field of secure storage, and more particularly embodiments of the invention relate to automated and remote access to secure storage containers.

### BACKGROUND OF THE INVENTION

In the prior art, important documents and items are often kept in safe-deposit boxes. The safe-deposit boxes are stored in a bank vault. This provides good security and a strong deterrent to theft. However, there are disadvantages to this type of storage. Safe-deposit box access is restricted to the business hours of the bank, limiting customer flexibility. Box access transactions are manually logged on paper, lead to inefficiency, potential errors and slower processing times. Clients must manage physical keys, increasing the risk of key loss or duplication. To access the boxes, clients must physically walk into a bank vault to access the box, which could lead to safety concerns or unwanted exposure. Finally, verification methods are often manual and outdated, raising the risk of fraud or identity mismanagement

### BRIEF SUMMARY

Shortcomings of the prior art are overcome and additional advantages are provided through the provision of a method for providing automated access to a storage container, including: receiving a request for access to a specific storage container that is located in a first secure enclosure; verifying the authenticity of the request, using at least one biometric factor; moving a robot into the first secure enclosure; and coupling the robot to the specific storage container.

According to some embodiments, the method further includes, after coupling the robot to the specific storage container: using the robot, removing the specific storage container from the first secure enclosure; and transporting the specific storage container to a second secure enclosure.

According to some embodiments, the second secure enclosure is a kiosk located in a bank branch building.

According to some embodiments, the method further includes unlocking an access door of the second secure enclosure, the access door configured to admit to a person into the second secure enclosure.

According to some embodiments, the storage container includes two or more locks which are mechanically in parallel, the method further comprising using the robot to unlock one of the two or more locks.

According to some embodiments, the method further includes using the robot to replace the specific storage container in the first secure enclosure.

According to some embodiments, the method further includes, after coupling the robot to the specific storage container: imaging contents of the storage container using a camera; and transmitting the images to a display.

According to some embodiments, the camera is carried by the robot, and the specific storage container includes a camera port through which the camera can image the contents.

According to some embodiments, the camera is disposed inside the storage container, and the images are transferred from the camera to the robot, and subsequently to the display.

According to some embodiments, the images are transmitted wirelessly.

According to some embodiments, the display is located in a second secure enclosure.

According to some embodiments, the display is located at a remote computer.

According to some embodiments, the first secure enclosure is a vault located in a bank branch building.

According to some embodiments, the storage container is a safe deposit box.

According to some embodiments, the method further includes using an electronic signature as part of the verification.

According to some embodiments, the first secure enclosure and the second secure enclosure are both located in a common building.

According to some embodiments, the first secure enclosure and the second secure enclosure are part of a contiguous space; there is a transfer door separating the first secure enclosure from the second secure enclosure; and there is an access door permitting selective access to the second secure enclosure.

According to some embodiments, the request is transmitted to the computing system from a remote computing system, over a data network.

Additionally, disclosed herein is a system for providing automated access to a storage container, including: a plurality of storage containers located in a first secure enclosure; a robot having access to the first secure enclosure, wherein the robot is programmed to: receive a request for access to a specific storage container of the plurality of storage containers; verify the authenticity of the request, using at least one biometric factor; move into the first secure enclosure; and couple to the specific storage container.

According to some embodiments, the robot is for the programmed to, after coupling to the specific storage container, at least one of: (a) remove the specific storage container from the first secure enclosure and transport the specific storage container to a second secure enclosure; and (b) image contents of the storage container using a camera and transmit the images to a display.

The features, functions, and advantages that have been described herein may be achieved independently in various embodiments of the present invention including computer-implemented methods, computer program products, and computing systems or may be combined in yet other embodiments, further details of which can be seen with reference to the following description and drawings.

### BRIEF DESCRIPTION OF THE SEVERAL VIEWS OF THE DRAWINGS

One or more aspects are particularly pointed out and distinctly claimed as examples in the claims at the conclusion of the specification. The foregoing as well as objects, features, and advantages of one or more aspects are apparent from the following detailed description taken in conjunction with the accompanying drawings in which:

FIG. 1 illustrates an enterprise system, and environment thereof, in accordance with an embodiment of the present invention;

FIG. 2 is a diagram of a building containing secure enclosures, along with a robot;

FIG. 3 is a front view of a kiosk shown in FIG. 2;

FIG. 4 is a front view of a safe-deposit box;

FIG. 5 is partially broken away side view of the safe-deposit box of FIG. 4;

FIG. 6 is a top view of the safe-deposit box of FIG. 4;

FIG. 7 is a side view of the safe-deposit box of FIG. 4, in an open position;

FIG. 8 is a side view of an exemplary robot; and

FIG. 9 is a diagram of an alternative arrangement of a building containing secure enclosures, along with a robot.

### DETAILED DESCRIPTION

Aspects of the present invention and certain features, advantages, and details thereof are explained more fully below with reference to the non-limiting examples illustrated in the accompanying drawings. Descriptions of well-known processing techniques, systems, components, etc. are omitted so as to not unnecessarily obscure the invention in detail. It should be understood that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure.

Note further that numerous inventive aspects and features are disclosed herein, and unless inconsistent, each disclosed aspect or feature is combinable with any other disclosed aspect or feature as desired for a particular embodiment of the concepts disclosed herein.

Unless described or implied as exclusive alternatives, features throughout the drawings and descriptions should be taken as cumulative, such that features expressly associated with some particular embodiments can be combined with other embodiments.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code, as referred to in this application, can include both software and hardware. For example, program code in certain embodiments of the present invention can include fixed function hardware, while other embodiments can utilize a software-based implementation of the functionality described. Certain embodiments combine both types of program code.

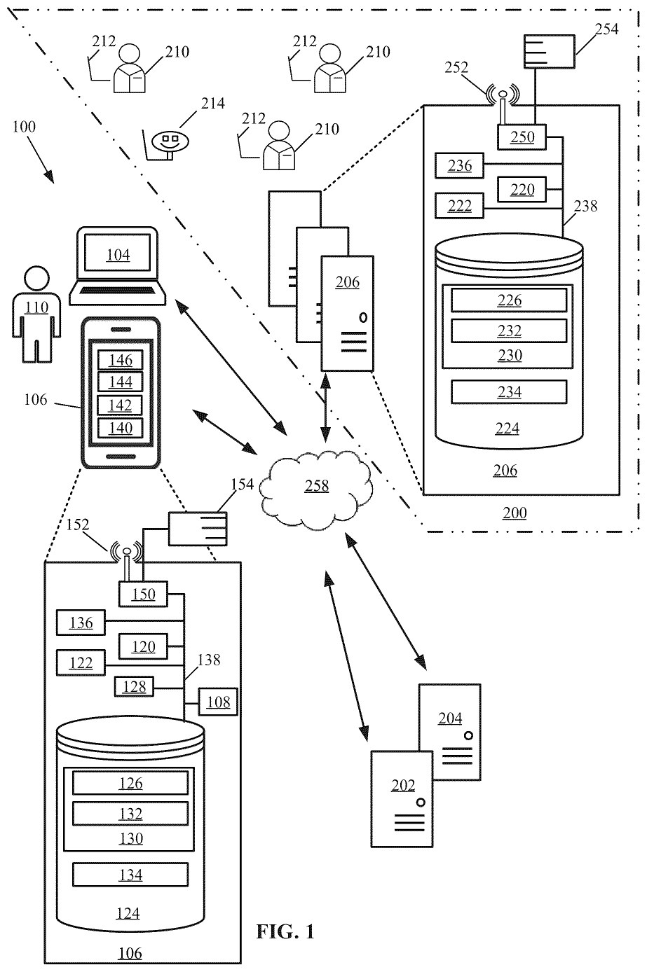

FIG. 1 illustrates a system 100 and environment thereof, according to at least one embodiment, by which a user 110 benefits through use of services and products of an enterprise system 200. The environment may include, for example, a distributed cloud computing environment (private cloud, public cloud, community cloud, and/or hybrid cloud), an on-premise environment, fog computing environment, and/or an edge computing environment. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

According to various embodiments, the memory device 122 and storage device 124 may be combined into a single storage medium. The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data.

Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Further non-limiting examples of input devices and/or output devices include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

The user device, referring to either or both of the computing device 104 and the mobile device 106 may also include a positioning device 108, which can be for example a global positioning system device (GPS) configured to be used by a positioning system to determine a location of the computing device 104 or mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device (referring to either or both of the computing device 104 and the mobile device 106). As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing system 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the computing device 104 and mobile device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated system 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

The network 258 may incorporate a cloud platform/data center that support various service models including Platform as a Service (PaaS), Infrastructure-as-a-Service (IaaS), and Software-as-a-Service (SaaS). Such service models may provide, for example, a digital platform accessible to the user device (referring to either or both of the computing device 104 and the mobile device 106). Specifically, SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes.

In certain embodiments, one or more of the systems such as the user device (referring to either or both of the computing device 104 and the mobile device 106), the enterprise system 200, and/or the external systems 202 and 204 are, include, or utilize virtual resources. In some cases, such virtual resources are considered cloud resources or virtual machines. The cloud computing configuration may provide an infrastructure that includes a network of interconnected nodes and provides stateless, low coupling, modularity, and semantic interoperability. Such interconnected nodes may incorporate a computer system that includes one or more processors, a memory, and a bus that couples various system components (e.g., the memory) to the processor. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

The computing system 206 described above may be used in conjunction with other hardware and software to provide secure automated access to storage containers.

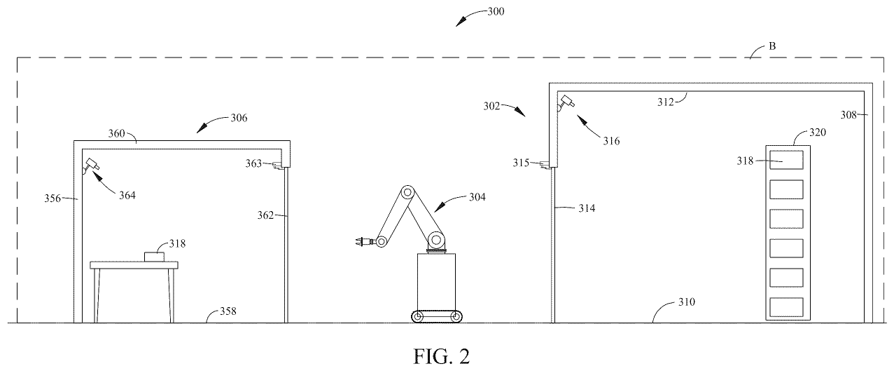

FIG. 2 illustrates a system 300 for providing secure access to a storage container including a vault 302, a robot 304, and a kiosk 306.

The vault 302 includes enclosing walls 308, a floor 310, a roof 312, and a vault door 314. The materials and design of the vault 302 are configured to prevent easy access. Materials such as steel and reinforced concrete can be used. The vault door 314 may be large and heavy with strong locking mechanisms. The vault door 314 may be equipped with access control means 315 for automated selective access such as a remotely-operated lock, a powered door operator, or both. The access control means 315 may be in data communication with computing system 206, for example via network 285 shown in FIG. 1. The vault 302 may be protected by a combination of devices such as combination locks, key locks, time locks, security cameras 316, alarms, and sensors such as motion detectors and/or weight sensors. As a whole, the vault 302 defines a “secure enclosure”.

Stored within the vault 302 is a plurality of safe-deposit boxes 318. These are an example of a type of storage container. The safe-deposit boxes 318 are typically stacked on shelves or racks 320 so they can be individually removed.

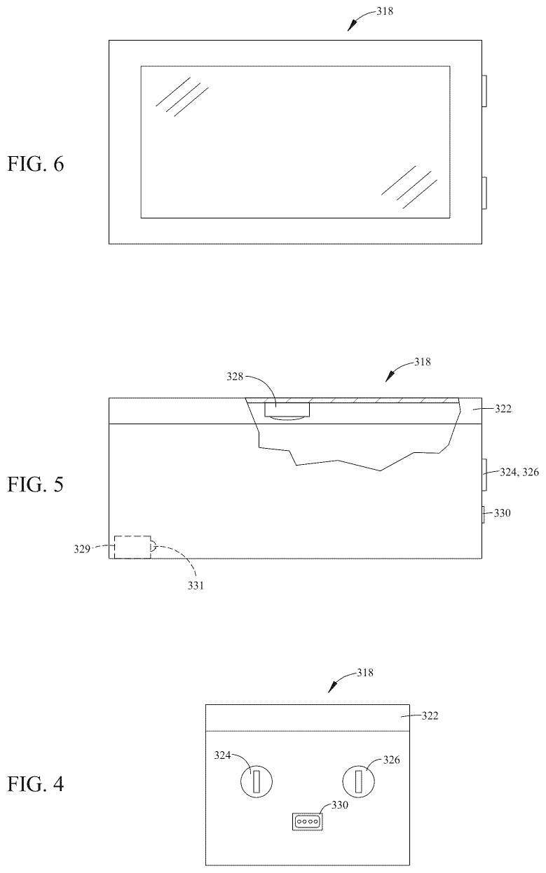

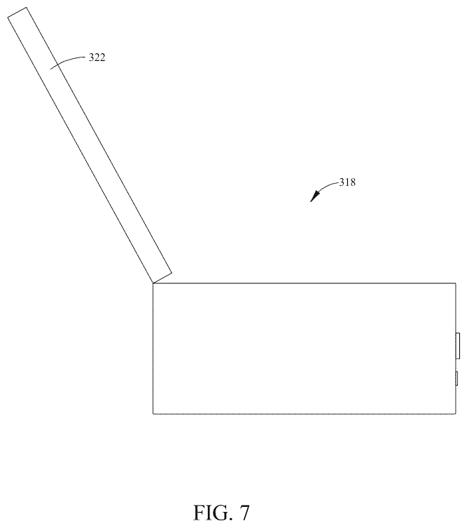

FIGS. 4-7 illustrate details of an exemplary safe-deposit box 318. It is a small enclosure, typically constructed of metal, with a lid 322 movable between an open position (FIG. 7) and a closed position (FIG. 5 point). The lid 322 may be selectively secured in the closed position by one or more locks. In the illustrated example, there is a first lock 324 and a second lock 326 which are mechanically “in parallel”, meaning that both locks must be unlocked to release the lid 322.

As used herein, the term “lock” can refer not only to a key-operated mechanical lock, but to any device capable of moving between an engaged (locked) position or state and a disengaged (unlocked) position or state. Nonlimiting examples of types of locks include physical key locks, electronic locks using biometric data, which is uniquely identifiable information taken from a human body (e.g., fingerprint scan, face scan, retina scan, palm scan, etc.), electronic locks using a physical token (e.g., wireless key fob, application on a mobile device, near field communication (“NFC”) card, or a radiofrequency identification (“RFID”) chip implanted in a person's body). Either or both of the locks 324, 326 can be configured for multi-factor authentication, using some or all of physical keys, personal identification numbers (PINs), biometrics, or electronic locks. The locks 324, 326 may use different locking methods in any combination of the above. For example, the first lock 324 may use a physical key while the second lock 326 uses a fingerprint scanner. If the locks use physical keys, they may be keyed differently, requiring two separate keys to operate them.

Optionally, a camera 328 may be mounted inside the safe-deposit box 318. It may be a digital camera, such as a CCD device. The camera 328 may be configured to transmit still images or video outside of the safe-deposit box 318. In one embodiment, the camera 328 may be coupled to a transceiver so that it can wirelessly transmit data. Example of wireless transmission protocols include Wi-Fi and Bluetooth. In one embodiment, the camera 328 may be coupled to physical connections (e.g. electrical connector port 330) which may be used to transfer data.

The safe-deposit box 318 may include a computing device 329 including one or more processors and means for data communication such as a network card or wireless transceiver. These may be used for data communication, for example over the network 258 shown in FIG. 1.

Optionally, the camera 328 may incorporate 3D scanning means to provide better visibility of depth and texture for better clarity. This may be done, for example by incorporating two or more spaced-apart cameras for stereo imaging, or by incorporating a laser 3D scanner.

Optionally, the safe-deposit box 318 may incorporate a motion detector 331 such as an accelerometer. This may be coupled to the computing device 329. The computing device 329 may be programmed to deactivate the camera 328 after a timeout period during which no motion has been detected. This ensures privacy of the safe-deposit box 318 when it is closed. Alternatively or in addition to this function, the computing device 329 may be programmed to transmit an alert to the computing system 206 if unauthorized motion is detected.

Optionally, the safe-deposit box 318 may be equipped with a camera port 332 of a transparent material, permitting viewing of the contents, as described in more detail below.

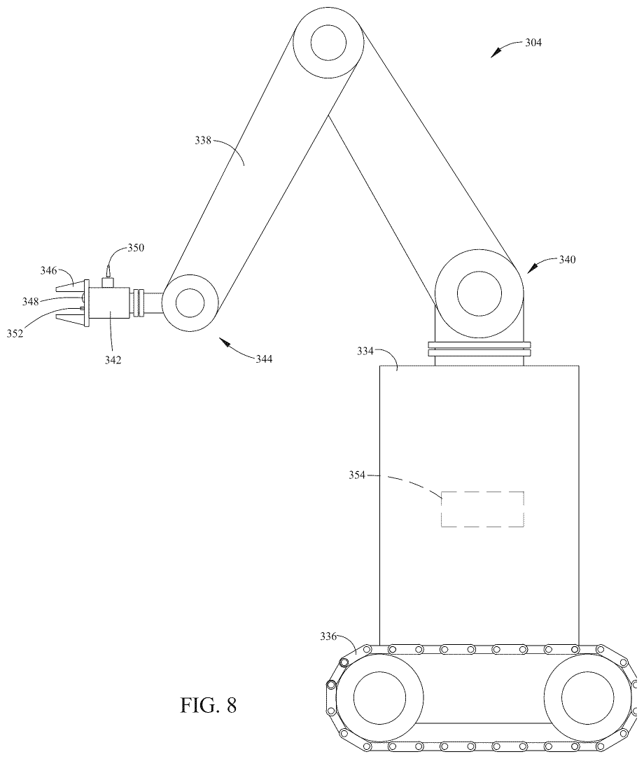

FIG. 8 illustrates the robot 304 in more detail. The robot 304 includes a body 334.

Optionally, the robot 304 may be mobile. In the illustrated example, the body 334 is mounted on a pair of independently-operable tracks 336 that provide mobility. The robot 304 includes a multi-jointed manipulator arm 338 which is capable of movement in several axes. A proximate end 340 of the manipulator arm 338 is mounted to the body 334. An end effector 342 is mounted at a distal end 344 of the manipulator arm 338. The end effector 342 is configured to selectively engage the safe-deposit box 318. It may be configured for example, as one or more clamps 346, hooks, or fingers. Alternatively, means such as an electromagnet could be used as an end effector. Optionally, the end effector 342 may include a camera 348. Optionally, the robot 304 may include means for transferring data from the safe-deposit box 318. For example, it may include a wireless transceiver 350 for communicating with the camera 328 described above. As another example, the robot 304 may include an electrical connector port 352 for making electrical contact with the electrical connector port 330 of the safe-deposit box 318 (if so equipped).

The main body of the robot 304 includes components (not separately illustrated) such as a power source, motors or actuators for driving the tracks 336 or other movement components, motors or actuators for driving the manipulator arm 338, and one or more processors embodied in a computing device 354 for executing software to carry out the functions of the robot 304 the computing device 354 is equipped for network communication, for example through network 258 shown in FIG. 1. Robots of this general type are commercially available and may be adapted for use of the present invention through suitable modification of their programming.

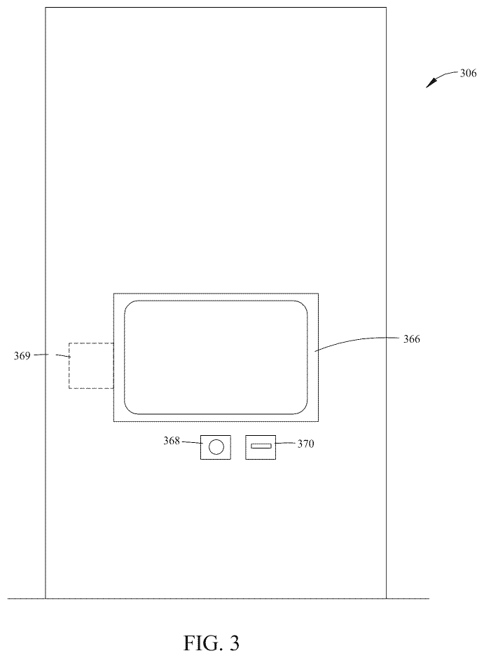

The robot 304 is usable in conjunction with the kiosk 306 or other suitable security enclosure. FIGS. 2 and 3 illustrate the kiosk 306 comprising enclosing walls 356, a floor 358, a roof 360, and an access door 362. The kiosk 306 may be constructed of materials intended to prevent easy access as described above for the vault 302. The access door 362 is configured, i.e., sized and sheet to permit access for a person and/or robot 304. The access door 362 may be equipped with access control means 363 for automated selective access such as a remotely-operated lock, a powered door operator, or both. The access control means 327 may be in data communication with computing system 206, for example via network 285 shown in FIG. 1. The kiosk 306 may be protected by a combination of devices such as combination locks, key locks, time locks, security cameras 364, alarms, and sensors. As a whole, the kiosk 306 defines a “secure enclosure”. In the example of FIG. 1, The kiosk 306 is separate from the vault 302, with both the kiosk 306 and the vault 302 being disposed in a building “B”, depicted schematically. For example the building B may be a bank branch.

The kiosk 306 further includes access controls. For example, it may include a display 366. The display 366 may be a touch screen or it may have separate input controls such as a keyboard or keypad. The access controls are configured to permit access to the kiosk electronic functions, such as the view-only function described in more detail below, as well as physical passage through the access door 362. The access controls may include a biometric scanner 368 (e.g. fingerprint reader, face scanner, palm scanner, etc.). The access controls may include a wireless device reader 370 (e.g. NFC or RFID reader). The kiosk 306 may include a computing device 369 including one or more processors for performing access control and verification functions. It may be in network communication with the computing system 206, for example via the network 285 depicted in FIG. 1.

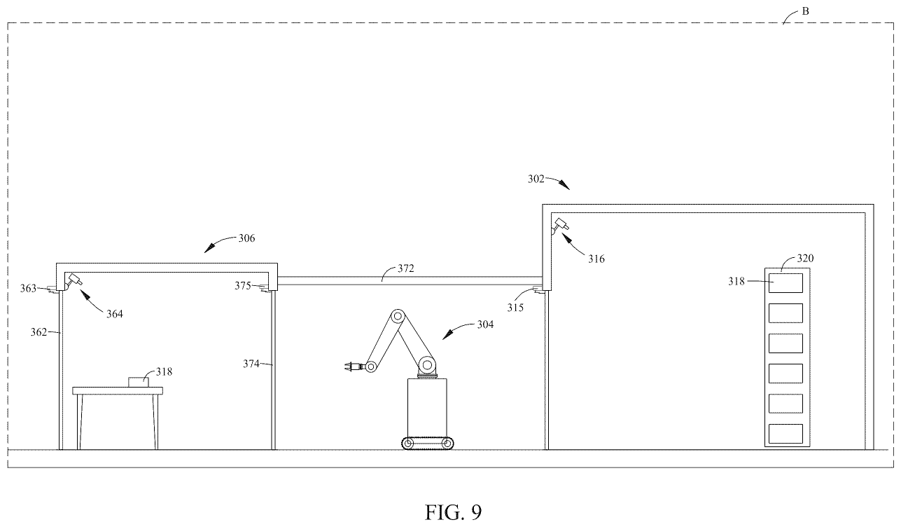

FIG. 9 illustrates an alternative embodiment in which the kiosk 306 and the vault 302 are enclosed in a building B and are interconnected by an enclosed passageway 372. In contrast to the embodiment of FIG. 1, The vault 302 and the kiosk 306 define a continuous secure enclosure. In this example, the kiosk 306 includes an access door 362 that communicates with the remainder of the building B, as well as a transfer door 374 that selectively blocks the kiosk 306 from the passageway 372. The transfer door 374 may be equipped with access control means 375 for automated selective access such as a remotely-operated lock, a powered door operator, or both. The access control means 375 may be in data communication with computing system 206, for example via network 285 shown in FIG. 1.

The system described above may be employed to provide a client with access to their safe-deposit box 318. The access may be view-only or physical access.

In a first step, the client approaches the kiosk 306 and interacts with the access controls to check in and gain access. For example, they may operate the display 366 to input identifying information or a PIN number. Alternatively or additionally, the client may interact with the biometric scanner 368, and/or the wireless device reader 370. A combination of these methods may be used to provide multi factor authentication. Optionally, the client may provide an electronic signature as part of verifying the request

Based upon the inputs described above, the system 300 verifies the authenticity of the client's request and the client's identity. When the client has checked in, they select whether they wish to have view-only access or physical access to the safe-deposit box 318.

If view-only access is selected, the robot 304 identifies the proper safe-deposit box 318 and navigates to it. If the robot 304 is mobile, it may travel to a location in the vault 302 within range of the manipulator arm 338. The robot 304 may gain access through vault door 314 by communication of a secured network request to the access control means 315.

In an optional embodiment, if view only access is desired, the client could send the request using the client computing device 104 or mobile device 106 for viewing, using for example the network 258 described above.

The robot 304 then couples to the safe-deposit box 318. In one example, the robot 304 moves manipulator arm 338 to bring its wireless transceiver 350 within data communications range of the camera 328. In another example, the robot 304 moves the manipulator arm 338 to bring the end effector 342 to the safe-deposit box 318, and engages its electrical connector port 352 with the electrical connector port 330 of the safe-deposit box 318. The robot 304 sends a signal to the camera 328 disposed inside the safe-deposit box 318 to power on and begin transmitting still images or video. The robot 304 relays the images from the camera 328 to the kiosk display 366, for example by wireless transmission. The client may observe the contents of the safe-deposit box 318.

Alternatively, the robot may physically couple to the safe-deposit box 318 using the end effector 342 and withdraw the safe-deposit box 318 from the rack 320, exposing the camera port 332. The robot may then use its onboard camera 348 to view the contents of the safe-deposit box 318 through the camera port. The robot 304 relays the images from the onboard camera 348 to the kiosk display 366, for example by wireless transmission. The client may observe the contents of the safe-deposit box 318. Alternatively, the robot 304 could really the images to the client computing device 104 or mobile device 106 for viewing, using for example the network 258 described above.

When the viewing session is complete, the robot 304 replaces the safe-deposit box in the rack (if removed) and decouples from the safe-deposit box 318.

If physical access is selected, the access door 362 of the kiosk 306 is unlocked so that the client may enter, using access control means 363.

The robot 304 identifies the proper safe-deposit box 318 and navigates to it. If the robot 304 is mobile, it may travel to a location in the vault 302 within range of the manipulator arm 338.

The robot 304 then couples to the safe-deposit box 318. It moves the manipulator arm 338 to bring the end effector 342 to the safe-deposit box 318, and physically connects to the safe-deposit box 318, for example using clamps 346. It withdraws the safe-deposit box 318 from the rack 320. The robot 304 then moves the safe-deposit box 318 to the kiosk 306. The robot 304 maintains the safe-deposit box 318 within the kiosk 306 the entire time that it is being accessed.

The client would then unlock the first lock 324 of the safe-deposit box 318. For example, if it is a mechanical block, the client would use a physical key in their possession. If other access control methods are used or multiple methods are required, the client would complete all steps of access.

Once the first lock 324 has been unlocked, the robot 304 unlocks the second lock 326. Various methods are possible with the step. In one example, the manipulator arm 338 physically inserts and turns a mechanical key. In another example, the manipulator the robot 304 is provided with a physical master key. In another example, the robot 304 may be provided with a encrypted digital key. In some embodiments, dual authentication may be required (that is, an action by the robot 304 and by a human user).

After both locks 324, 326 have been unlocked, the safe-deposit box 318 can be opened. The client has access to the interior of the safe-deposit box to remove and/or examine its contents, or insert additional items. During this process, the safe-deposit box 318 remains stationary and the client cannot physically remove it from the kiosk 306.

Once the client has finished accessing the safe-deposit box 318, they check out using the kiosk controls. Robot 304 returns safe-deposit box to the vault 302 and places it in the appropriate position in the rack 320.

The entire access process described above, whether view-only or physical, may be tracked, recorded, and logged for security, preventing unauthorized access or suspicious activity. For example, cameras 316 and 364 may record a series of still images or video which may be stored by computing system 206. Opening and closing events of the doors 314, 362, and/or 374 may be logged by their respective access control means 315, 363, and 375. Movement of the robot 304 may be logged by the onboard computing device 354. Movement data and/or images from the safe-deposit box 318 may be recorded by computing device 329. Data from all of these network-connected devices may be stored by computing system 206.

Aspects of the present invention are described herein with reference to flowchart illustrations and/or block diagrams of computer-implemented methods and computing systems according to embodiments of the invention. It will be understood that each block of the flowchart illustrations and/or block diagrams, and combinations of blocks in the flowchart illustrations and/or block diagrams, can be implemented by computer readable program instructions that may be provided to a processor of a general purpose computer, special purpose computer, or other programmable data processing apparatus (the term “apparatus” includes systems and computer program products). The processor may execute the computer readable program instructions thereby creating a means for implementing the actions specified in the flowchart illustrations and/or block diagrams. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the actions specified in the flowchart illustrations and/or block diagrams. In particular, the computer readable program instructions may be used to produce a computer-implemented method by executing the instructions to implement the actions specified in the flowchart illustrations and/or block diagrams.

The computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

In the flowchart illustrations and/or block diagrams disclosed herein, each block in the flowchart/diagrams may represent a module, segment, or portion of instructions, which comprises one or more executable instructions for implementing the specified logical function(s). In some implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

Computer program instructions are configured to carry out operations of the present invention and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

1. A method for providing automated access to a storage container, comprising:
receiving a request for access to a specific storage container that is located in a first secure enclosure;
verifying the authenticity of the request, using at least one biometric factor;
moving a robot into the first secure enclosure, using movement components of the robot; and
coupling the robot to the specific storage container; and
after coupling the robot to the specific storage container:
imaging contents of the storage container using a camera disposed inside the storage container;
transferring the images from the camera to the robot; and
transmitting the images from the robot to a display.

2. The method of claim 1, further comprising, after coupling the robot to the specific storage container:
using the robot, removing the specific storage container from the first secure enclosure; and
transporting the specific storage container to a second secure enclosure.

3. The method of claim 2, wherein the second secure enclosure is a kiosk located in a bank branch building.

4. The method of claim 2, further comprising unlocking an access door of the second secure enclosure, the access door configured to admit to a person into the second secure enclosure.

5. The method of claim 2, wherein the storage container includes two or more locks which are mechanically in parallel, the method further comprising using the robot to unlock one of the two or more locks.

6. The method of claim 2, further comprising using the robot to replace the specific storage container in the first secure enclosure.

7. (canceled)

8. (canceled)

9. (canceled)

10. The method of claim 1, wherein the images are transmitted wirelessly.

11. The method of claim 1, wherein the display is located in a second secure enclosure.

12. The method of claim 1, wherein the display is located at a remote computer.

13. The method of claim 1, wherein the first secure enclosure is a vault located in a bank branch building.

14. The method of claim 1, wherein the storage container is a safe deposit box.

15. The method of claim 1, further comprising using an electronic signature as part of the verification.

16. The method of claim 2, wherein the first secure enclosure and the second secure enclosure are both located in a common building.

17. The method of claim 2, wherein the first secure enclosure and the second secure enclosure are part of a contiguous space;
there is a transfer door separating the first secure enclosure from the second secure enclosure; and
there is an access door permitting selective access to the second secure enclosure.

18. The method of claim 1, wherein the request is transmitted to the computing system from a remote computing system, over a data network.

19. A system for providing automated access to a storage container, comprising:
a plurality of storage containers located in a first secure enclosure;
a robot having access to the first secure enclosure, wherein the robot is programmed to:
receive a request for access to a specific storage container of the plurality of storage containers;
verify the authenticity of the request, using at least one biometric factor;
move into the first secure enclosure; and
couple to the specific storage container; and
after coupling to the specific storage container:
image contents of the storage container using a camera disposed inside the storage container;
receive the images transferred from the camera; and
transmit the images to a display.

20. The system of claim 19, wherein the robot is further programmed to, after coupling to the specific storage container:
using the robot, remove the specific storage container from the first secure enclosure; and
transport the specific storage container to a second secure enclosure.

21. The system of claim 20, wherein the second secure enclosure is a kiosk located in a bank branch building.

22. The system of claim 20, wherein the robot is further programmed to unlock an access door of the second secure enclosure, the access door configured to admit a person into the second secure enclosure.

23. The system of claim 20, wherein the robot is further programmed to replace the specific storage container in the first secure enclosure.
